(19) United States
(12) Patent Application Publication
(10) Pub. No.: US 2026/0216918 A1
(43) Pub. Date: Jul. 30, 2026

(54) WEAR RESISTANT MIXER PADDLE FOR USE WITH ABRASIVE SLURRIES

(71) Applicant: UNITED STATES GYPSUM COMPANY, Chicago, IL (US)

(72) Inventor: David Russell BLACKBURN, Grayslake, IL (US)

(21) Appl. No.: 19/284,223

(22) Filed: Jul. 29, 2025

Related U.S. Application Data
(60) Provisional application No. 63/750,918, filed on Jan. 29, 2025.

(51) Int. Cl. B28C 5/08

(52) U.S. Cl. CPC B28C 5/0806

(57) ABSTRACT

A mixer paddle for use in producing abrasive slurries is provided. Included on the mixer paddle is a tapered body with a first tip and an opposite second tip; each tip having a wear zone and a recess formed in the wear zone. A Tungsten Carbide tile is fastened in each wear zone. An exterior surface of the body has hardfacing applied, and the hardfacing is smoothed after application by electronic discharge machining.

### RELATED APPLICATION

This application is a Non-Provisional of, and claims 35 U.S.C. 119 priority from, US Provisional Patent Application Serial No. 63/750,918 filed January 29, 2025, the entire contents of which are incorporated by reference herein.

### BACKGROUND

The present invention relates generally to the processing of abrasive slurries used for example, in the preparation of building panels, and more particularly to improvements in mixers used to mix such abrasive slurries.

In the production of cement board building panels, commonly used as a substrate for ceramic tile, outdoor construction and other environments exposed to moisture, mixers are used to continuously mix concrete slurry for the production of cement board, including Durock® brand panels. A common problem incurred in the production of these slurries is wear and tear on the typically steel-based mixer components.

A popular mixer used in the production of such slurries is known as a Continuous Processor (“CP”) manufactured by Readco Kurimoto of York, Pennsylvania. A Readco CP features a pair of parallel, motor-driven shafts rotating within a processing chamber, each shaft equipped with a first zone with helical augers on each shaft, followed by a second zone with a plurality of tapered and ultimately pointed, symmetrically ovate paddles rotating with each shaft and oriented at various angles of rotation upon the shafts. By positioning the paddles at various angles, and dimensioning the paddles to reduce the clearance between the adjacent paddles on each shaft, the slurry material urged by the first zone of augers into the second zone, becomes thoroughly mixed. The second or paddle zone is where much of the mixing or comminution of ingredients takes place due to the speed of the shafts, in combination with the impacts to the material provided by the paddles. After moving through the paddle zone, the ingredients, now mixed into a slurry, may move to a processor outlet for further processing, or may pass into additional zones with additional augers or mixing elements, depending on the particular substance being mixed, before moving through the processor outlet.

When mixing abrasive slurries of the type used to make construction panels, both wet and dry ingredients are combined in the CP, and the dry ingredients include aggregate(s) and/or dry cement(s), which create a very abrasive slurry. While the CP typically features stainless steel components which are used in the food industry and the like, these components need to be strengthened to withstand the extreme environment of an abrasive slurry.

One current solution to the problem of mixer wear is to “build up” the worn areas, particular on paddles, by welding with hard-facing wire or rod. This operation needs to be accomplished when the mixer is not operational, and involves the full attention of at least one skilled craftsman for multiple hours, typically 2-4 times per month. Obviously, when the mixer is out of operation, production suffers.

Despite such known techniques for modifying the CP components to withstand abrasive slurries, there is still a problem of such devices needing more frequent maintenance due to abrasion-induced operational wear. Particularly susceptible to such wear are the ovate mixer paddles. Severely worn mixer parts result in operating inefficiencies such as lower production speeds and may also result in undesirable properties of the concrete mixture and lower early-age strength of finished products.

Thus, there is a need for an improved mixer usable with abrasive slurries that addresses the above-described need.

### SUMMARY

The above-listed need is met or exceeded by the present wear resistant mixer paddle for abrasive slurries for use with a mixer, also referred to as a CP or Continuous Processor, which includes parts that are specifically designed to overcome the problem of rapid wear in the process of continuous mixing of abrasive slurry used to form building panels. As a result, the working life of internal mixer components is extended, and provides several benefits, including a reduction in the time required by skilled craftsmen to repair worn surfaces on a regular basis, improved quality of abrasive slurry over an extended period, and reduction of manufacturing inefficiencies caused by worn mixer components.

It has been found that conventional CP paddles, when used in the production of abrasive slurries, show premature wear at the opposite leading edges near the point or tips of the paddle. The conventional solution to the problem of wear is to “build up” the worn tips by welding with hard-facing wire or rod. As described above, this can only be accomplished when the mixer is not being used for production, and it requires the full attention of at least one skilled craftsmen for multiple hours, typically two to four times per month.

Improvements in the present mixer include creating recesses at the paddle tips on the wear side, in a designated “wear zone” for accommodating wear elements, applying hardfacing onto the paddle exterior by welding, using EDM (electrical discharge machining) to create desired, beneficial smoothness to machined paddle surfaces, and the use of Tungsten Carbide tiles at the wear element recess for providing targeted extreme abrasion resistance. Preferably, the tiles are attached by brazing or the like. Further, the tiles are dimensioned to be relatively thin, on the order of 1/16 inch.(1.59 mm) thick, which will readily be comminuted in the CP mixer in the event the tile detaches from the paddle during operation. As such, prematurely detached tiles do not become potentially damaging tramp metal.

A combination of the use of the carefully placed thin Tungsten Carbide tiles, with the EDM-smoothed exterior paddle hardfacing, results in an appreciably smoother paddle exterior than found in mixer paddles which have been overlayed with hardfacing in a conventional manner. Further, these features provide an improvement in mixer paddle resistance to premature wear during the formulation and processing of abrasive slurries.

More specifically, a mixer paddle for use in producing abrasive slurries is provided. Included on the mixer paddle is a tapered body with a first tip and an opposite second tip; each tip having a wear zone, and a recess formed in the wear zone. An exterior surface of the body has hardfacing applied; and the hardfacing is smoothed after application by electronic discharge machining (EDM). A Tungsten Carbide tile is fastened in each wear zone.

In an embodiment, the Tungsten Carbide tile has a thickness of approximately 1/16 inch (1.59 mm). In an embodiment, after the smoothing, the hardfaced mixer paddle exterior has a surface finished with a Ra of 125 micro-inches (3.2 μm) and Wt of 0.010 inches (0.025 cm). In a preferred embodiment, the Tungsten Carbide tiles have an Ra value of less than 32 micro-inches (0.8 μm) and Wt value of less than 0.0062 inches (0.0157cm).

In an embodiment, the wear zones are on opposite facing tip surfaces from each other. In an embodiment, the hardfacing applied to the paddle exterior includes Tungsten Carbide.

In another embodiment, a mixer paddle is provided for use in producing abrasive slurries, and includes a tapered body with a first tip and an opposite second tip; each tip having a wear zone, and a recess formed in the wear zone; an exterior surface of the body having hardfacing applied; and the hardfacing being smoothed by electronic discharge machining, to have an Ra value of 125 micro-inches (3.2 μm), where Ra is the average roughness, calculated as the average of absolute values of surface height deviations measured from the mean plane to the peaks and valleys of small scale deviations less than 0.020 inches (0.050cm) in spacing, and a Wt value less than 0.010 inches (0.025 cm), where Wt is total waviness measured as the distance from highest peak to lowest valley in the relatively larger scale variations, greater than 0.020 inches in spacing, and measured over a span of 0.8 inches (2.0cm). A Tungsten Carbide tile fastened in each wear zone, the tile having a thickness of approximately 1/16 inch (1.59 mm). In an embodiment, the Tungsten Carbide tiles have an Ra value of less than 32 micro-inches (0.8 μm) and Wt value of less than 0.0062 inches (0.0157cm).

In still another embodiment, a method of making a CP mixer paddle for use with abrasive slurries includes the steps of: providing a mixer paddle with a tapered body including a first tip and an opposite second tip, each tip having a wear zone, and forming a recess in the wear zone, applying hardfacing to an exterior surface of the body; smoothing the hardfacing by electronic discharge machining; and fastening a Tungsten Carbide tile in each wear zone.

### BRIEF DESCRIPTION OF THE DRAWINGS

FIG. 1 is a fragmentary side perspective view of a mixer suitable for use with the present paddle;

FIG. 2 is a cross-section taken along the line 2-2 of FIG. 3 and in the direction generally indicated;

FIG. 3 is a fragmentary top perspective of the present mixer;

FIG. 4 is an exploded perspective view of the present mixer paddle;

FIG. 5 is a top perspective view of the present mixer paddle;

FIG. 6 is a top view of the present mixer paddle with hardfacing; and

FIG. 7 is a side view of an EDM machine in operation.

### DETAILED DESCRIPTION

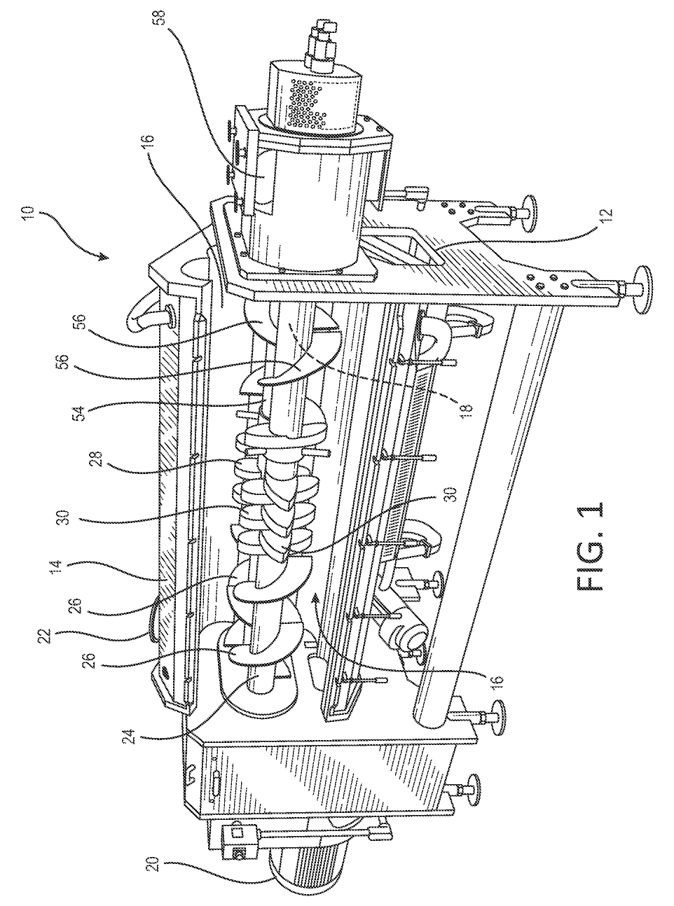

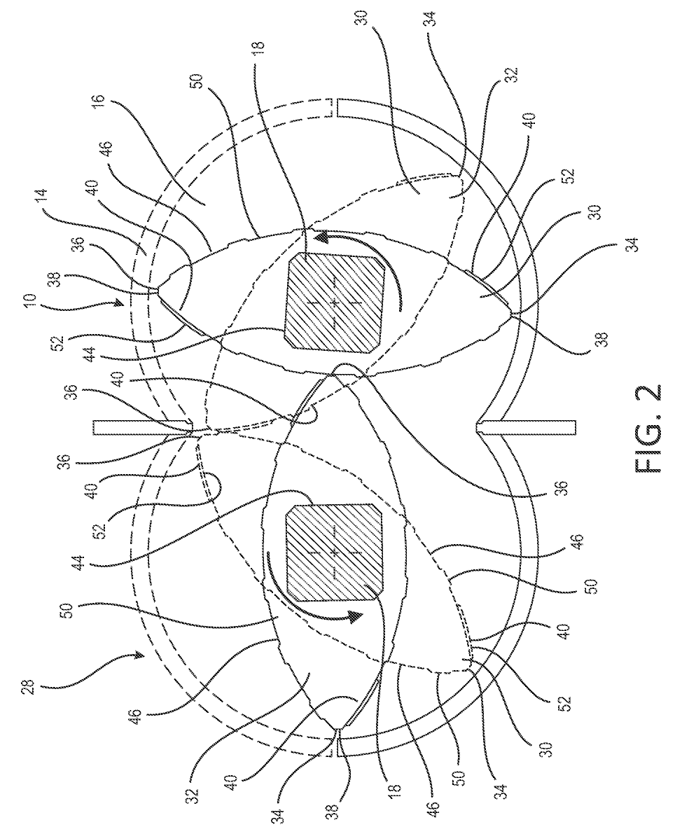

Referring now to FIGS. 1-3, a Continuous Processor mixer or CP of the type manufactured by Readco Kurimoto of York, Pennsylvania is generally designated 10. A mixer housing 12 includes a hinged lid 14 that encloses a mixer or processing chamber 16. Within the mixer chamber 16 is a pair of parallel, rotating shafts 18 powered by a motor 20. As is known in the art, the shafts 18 have a non-circular vertical cross-section (FIG. 2) upon which are mounted a plurality of components for common rotation.

An inlet 22 of the mixer chamber 16 is the entryway for slurry ingredients, including dry components like cement, additives such as accelerators, surfactants, and the like as known in the art, and optionally includes water or other liquids used to form a slurry. Optionally, secondary inlet(s) are provided for the insertion of additional dry or wet ingredients. In the mixer chamber 16, various production functions are performed by specially designed, shaft-driven components. A first zone 24 is used to convey slurry ingredients from the inlet 22, and is made of at least one and preferably a plurality of helical augers 26 mounted on each of the shafts 18. The particular pitch and configuration of the augers 26 is contemplated as varying depending on the type of slurry being produced.

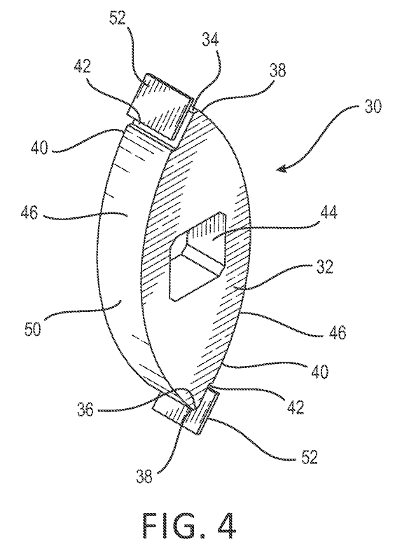

Referring now to FIGS. 1-4, next, downstream from the first zone 24 is a second zone 28 configured for mixing the slurry ingredients together. This zone 28 is made up of a plurality of mixer paddles 30 mounted upon each of the shafts 18. Each paddle 30 is generally ovate in shape, with a tapered body 32 with a first tip 34 and an opposite second tip 36. Each of the tips 34 and 36 are pointed, forming an edge 38. Each tip 34, 36 has a wear zone 40 adjacent the corresponding edge 38 where most of the mixing abrasion occurs. The location of the wear zone 40 varies with the direction of rotation of the shafts 18, but will be located on the forward edge of the tips 34, 36 of the paddle 30 as the paddle rotates, and the wear zones 40 of the respective tips 34, 36 will be on opposite sides. Each paddle 30 has a recess 42 (best seen in FIG. 4) formed in the wear zone 40, and have an axial, non-circular bore 44 for slidingly and complementarily engaging the respective shaft 18 for common rotation.

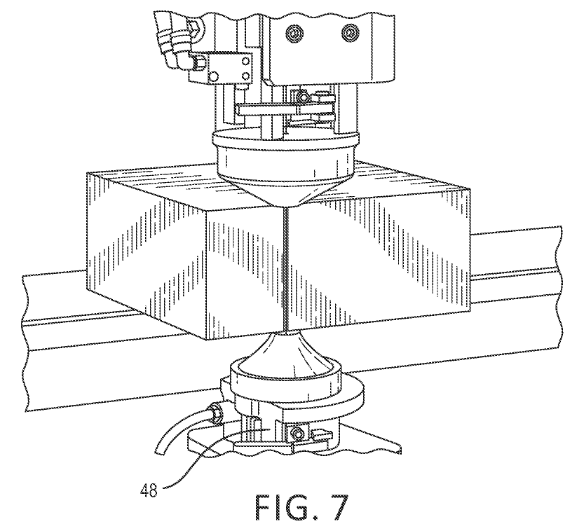

The paddles 30 are preferably fabricated from stainless steel and finished with a layer of hard-facing material 46 known as Addifix 796, a Tungsten Carbide hard facing overlay having a hardness of 68-72 Rockwell “C”. The Addifix 796 material 46 includes a relatively higher density of Tungsten Carbide to nickel chromium boron, and is applied having a slightly larger-than-needed cross-sectional dimension, to account for the subsequent trimming/smoothing operation. Tungsten Carbide is approximately three times as stiff as steel, with a Youngs Modulus of approximately 530–700 GPa, and is twice as dense as steel. Tungsten Carbide is corundum (α- Al₂O₃) in hardness approaching that of a diamond. Next, the paddles 30 are trimmed to size and smoothed using EDM 48 (FIG. 7). During this EDM stage, the recesses 42 are also machined into the paddle 30.

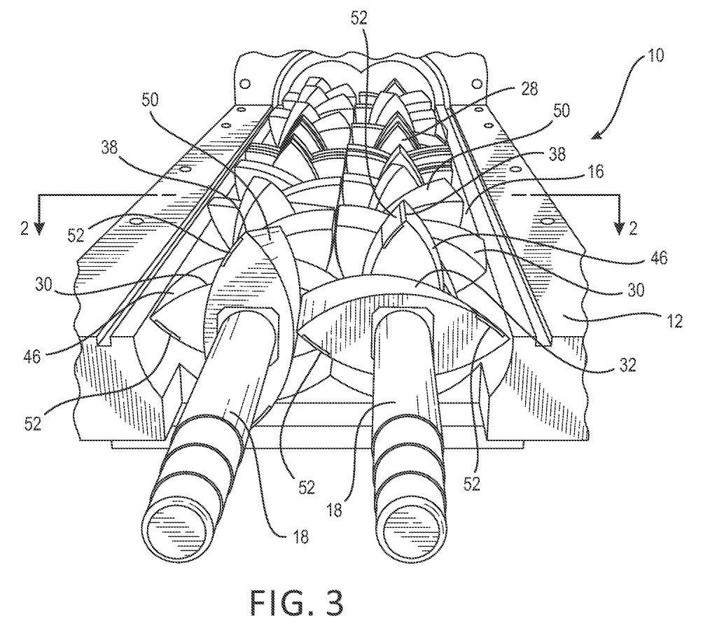

Referring now to FIGS. 2 and 3, the paddles 30 are mounted to the shafts 18 at various angular offsets, including but not restricted to 90° offset (FIG. 3) to each adjacent paddle, to provide an irregular surface to the incoming components which enhances the mixing action. Also, the axial length of each paddle 30 is calculated in relation to the lateral spacing of the rotating shafts 18, so that when shaped properly, the paddles 30 are self-cleaning because peripheral surfaces 50 of one paddle are continuously swept clean by the tips of its partner on the adjacent shaft. Gaps between the tips 34, 36 of one paddle 30 and the peripheral surface of its mate is constant in any rotational position. Maintaining a narrow gap between paddle tips 34, 36 and paddle bodies 32, as well as paddle tips to a liner surface in the mixer lid 14 or the chamber 16 is important for maintaining a self-cleaning mixer 10 that effectively and continuously mixes fast-setting concrete slurry for hours or days without the need to stop and clean the mixer.

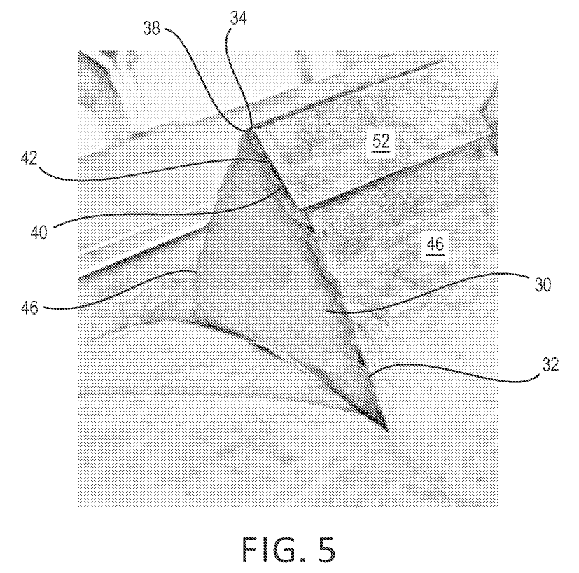

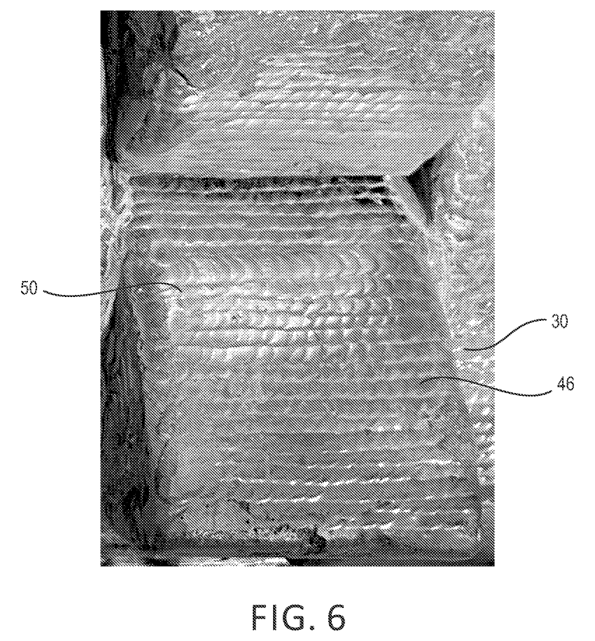

Referring now to FIGS. 5-7, as the hardfacing material 46 is applied to the entire peripheral surface 50 of the paddles 30, it has been found that while the hardfacing material resists abrasion, the surface is ridged or washboard in appearance (FIG. 6). Enhanced abrasion resistance is achieved if the hardfacing material 46 is smoothed, preferably using electrical discharge machining EDM 48 (FIG. 7).

Prior to smoothing by the EDM 48, the hardfaced paddle peripheral surface 50 is characterized by an Ra or average roughness value of 240 micro-inches (6.1μm) and a Wt or total waviness value of 0.024 inches (0.0609cm), where Ra is the average roughness, calculated as the average of absolute values of surface height deviations measured from the mean plane to the peaks and valleys of small scale deviations less than 0.020 inches (0.050cm) in spacing, and Wt is total waviness measured as the distance from highest peak to lowest valley in the relatively larger scale variations, greater than 0.020 inches in spacing, and measured over a span of 0.8 inches (2.0cm). However, after the EDM 48, the roughness of the paddle surface 50 is characterized by an Ra value of 125 micro-inches (3.2 μm), and Wt value of 0.010 inches (0.025 cm).

Referring now to FIGS. 4 and 5, another feature of the present paddle 30 is that a wear resistant tile 52 is secured in the wear zone recess 42, preferably by brazing, welding, or similar technique that allows for replacement of damaged tiles. Preferably, the tile 52 is made of Tungsten Carbide, and more preferably Federal Carbide FC12M. Also, the tile 52 is preferably relatively thin, preferably 1/16 in (1.59 mm) thick for a balance of toughness, brittleness, and abrasion resistance.

The Tungsten Carbide tiles 52 are tough enough to avoid brittle failure during operation. However, if the tiles 52 become detached during operation, for example due to damage caused by tramp metal being inside the mixer 10, they are preferably thin enough and brittle enough to break apart into small pieces, avoiding damage to downstream mixer parts. The surface of the Tungsten Carbide tiles have an Ra value of less than 32 micro-inches (0.8 μm) and a Wt value less than 0.0062 inches (0.0157cm).as fabricated, and without a need for the EDM 48.

Additionally, if EDM 48 and carbide tiles 52 are not employed, the high-wear zones 40 of the paddles 30 near the tips 34, 36 will wear within two to four weeks when used for normal production of cement board, requiring welding overlay with hardfacing material to restore the surface. With conventional paddles, this is done in the field, where it is much more difficult to apply uniform weld beads, and surface smoothness in the re-surfaced areas will be characterized by. an Ra value of 500 micro-inches (12.7μm) and Wt values of 0.039 inches (0.099 cm) or greater.

In comparison, when the present paddles 30 are employed, with EDM smoothing of the paddle surface 50 and Tungsten Carbide tiles 52 at the tips 34, 36, the lifespan before re-surfacing is required is expected to be several months.

Referring again to FIG. 1, downstream of the second or mixing zone 28, the mixer chamber 16 optionally features a third or evacuation zone 54. Preferably, this zone is equipped with augers 56 mounted on the shafts 18 that are configured for moving the mixed slurry out of the mixer chamber 16. Downstream of the mixing chamber 16, the mixer 10 features an outlet channel where the mixed slurry flows by gravity for further processing, as is known in the art. The outlet channel may optionally be fitted with an extractor assembly 58 to assist slurry flow out of the processor 10.

While a particular embodiment of the present wear resistant mixer paddles for use with abrasive slurries has been described herein, it will be appreciated by those skilled in the art that changes and modifications may be made thereto without departing from the invention in its broader aspects and as set forth in the following claims.

1. A mixer paddle for use in producing abrasive slurries, said paddle comprising:
a tapered body with a first tip and an opposite second tip;
each said tip having a wear zone, and a recess formed in said wear zone;
an exterior surface of said body having hardfacing applied;
said hardfacing being smoothed after application by electronic discharge machining; and
a Tungsten Carbide tile fastened in each said wear zone.

2. The mixer paddle of claim 1, wherein said Tungsten Carbide tile has a thickness of approximately 1/16 inch (1.59 mm).

3. The mixer paddle of claim 1, wherein an exterior of said paddle after said electronic discharge machining has an Ra value of 125 micro-inches (3.2 μm), and Wt value of 0.010 inches (0.025 cm).

4. The mixer paddle of claim 1, wherein said Tungsten Carbide tiles have an Ra value of less than 32 micro-inches (0.812 μm) and a Wt value less than 0.0062 inches (0.0157cm).

5. The mixer paddle of claim 1, wherein said wear zones are on opposite facing tip surfaces from each other.

6. The mixer paddle of claim 1, wherein said hardfacing applied to said paddle exterior includes Tungsten Carbide.

7. A mixer paddle for use in producing abrasive slurries, said mixer paddle comprising:
a tapered body with a first tip and an opposite second tip;
each said tip having a wear zone, and a recess formed in said wear zone;
an exterior surface of said body having hardfacing applied;
said hardfacing being smoothed by electronic discharge machining, to have an Ra value of 125 micro-inches (3.2 μm), and a Wt value of 0.010 inches (0.025 cm); and
a Tungsten Carbide tile fastened in each said wear zone, said tile having a thickness of approximately 1/16 inch.

8. The mixer paddle of claim 7, wherein said Tungsten Carbide tiles have an Ra value of less than 32 micro-inches (0.8 μm) and a Wt value less than 0.0062 inches (0.0157cm).

9. A method of making a CP mixer paddle for use with abrasive slurries, comprising the steps of:
providing a mixer paddle with a tapered body including a first tip and an opposite second tip;
each said tip having a wear zone, and forming a recess said wear zone;
applying hardfacing to an exterior surface of said body;
smoothing said hardfacing by electronic discharge machining; and
fastening a Tungsten Carbide tile in each said wear zone.

10. The method of claim 9, wherein said tile has a thickness of approximately 1.6 mm.

11. The method of claim 9, further including smoothing said paddle hardfacing using electronic discharge machining to have a have an Ra value of 125 micro-inches (3.2 μm), and a Wt value of 0.010 inches (0.025 cm).
